(19) United States
(12) Patent Application Publication
(10) Pub. No.: US 2026/0238842 A1
(43) Pub. Date: Aug. 13, 2026

(54) DISTRIBUTION SERVER AND USER TERMINAL

(71) Applicant: NTT DOCOMO, INC., Tokyo (JP)

(72) Inventor: Wataru AKASHI, Tokyo (JP)

(73) Assignee: NTT DOCOMO, INC., Tokyo (JP)

(21) Appl. No.: 19/153,374

(22) PCT Filed: Jan. 29, 2024
(86) PCT No.: PCT/JP2024/002695

§ 371 Date: Aug. 4, 2025

(30) Foreign Application Priority Data
Apr. 21, 2023 (JP) 2023-070170

(51) Int. Cl. H04N 21/258; H04N 21/234; H04N 21/431; H04N 21/472

(52) U.S. Cl. CPC H04N 21/25891; H04N 21/23418; H04N 21/4316; H04N 21/47217

(57) ABSTRACT

Provided is a distribution server capable of accurately providing a user with a scene matching the user's preferences. A distribution server 100 according to the present disclosure includes a video distribution unit 104 distributing a video to a user terminal 200 of one user and a keyword acquisition unit 103 acquiring keywords from a scene designated by the user in the video. The video distribution unit 104 distributes a presentation keyword selected from the keywords so as to be displayed on the user terminal 200 together with the video. Therefore, it is possible for the user to easily view the scene and the keywords of the scene, without displaying all of the keywords of the designated scene on the user terminal 200.

### TECHNICAL FIELD

The present invention relates to a distribution server distributing a video and a user terminal that receives the video and plays the video.

### BACKGROUND ART

Patent Literature 1 discloses a video recommendation device that can recommend a video scene matching the user's preferences. The video recommendation device generates recommendation information for recommending a video scene matching a user profile from video data stored in a video data storage unit, based on content tags and topic tags.

### CITATION LIST

### Patent Literature

Patent Literature 1: Japanese Unexamined Patent Publication No. 2010-288024

### SUMMARY OF INVENTION

### Technical Problem

In the video recommendation device disclosed in Patent Literature 1, since the video scene is provided as the recommendation information to the user, the user can visually understand that the video matches the user's preferences, but there are cases where the user still finds it difficult to understand the video.

Therefore, an object of the present invention is to provide a distribution server and a user terminal that can accurately provide a user with a scene matching the user's preferences.

### Solution to Problem

According to the present invention, there is provided a distribution server including: a video distribution unit distributing a video to a user terminal of one user; and a keyword acquisition unit acquiring keywords from a scene designated by the one user in the video. The video distribution unit distributes a presentation keyword selected from the keywords so as to be displayed on the terminal together with the video.

### Advantageous Effects of Invention

According to the present invention, it is possible to accurately provide a scene matching the user's preferences.

### BRIEF DESCRIPTION OF DRAWINGS

FIG. 1 is a diagram showing a video distribution system according to the present disclosure.

FIG. 2 is a block diagram showing a functional configuration of a distribution server 100.

FIG. 3 is a view showing a specific example of a video DB 105. FIG. 4 is a view showing a specific example of a user DB.

FIG. 5 is a view showing an overview of an operation of the distribution server 100 including a collaborative filtering process.

FIG. 6 is a flowchart showing a video distribution process of the distribution server 100 according to the present disclosure.

FIG. 7 is a flowchart showing the operation of the distribution server 100 acquiring scenes from a video.

FIG. 8 is a flowchart showing a process when a common keyword is registered in the user DB 106.

FIG. 9 is a diagram showing an example of a hardware configuration of the distribution server 100 according to an embodiment of the present disclosure.

### DESCRIPTION OF EMBODIMENTS

Embodiments of the present disclosure will be described with reference to the accompanying drawings. If possible, the same portions are designated by the same reference numerals, and a redundant description thereof will be omitted.

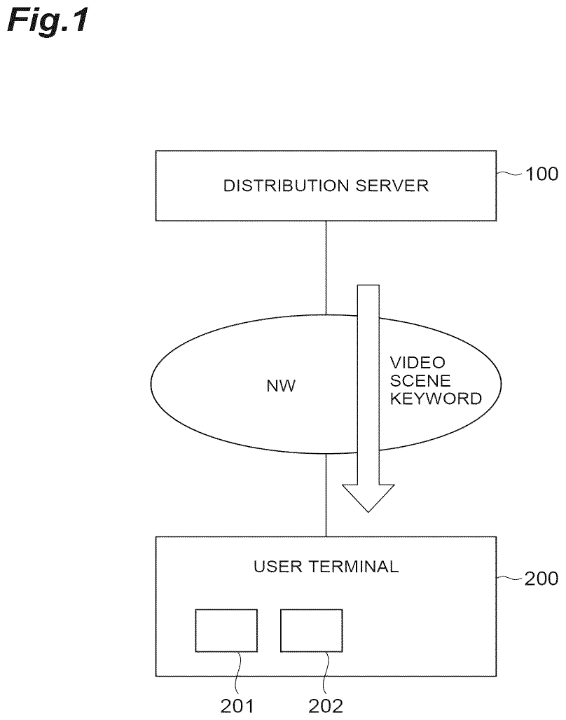

FIG. 1 is a diagram showing a video distribution system according to the present disclosure. The video distribution system includes a distribution server 100 and a user terminal 200. The distribution server 100 stores a plurality of videos and distributes a designated video in response to a request from the user terminal 200. The user terminal 200 plays and displays the distributed video. The distribution server 100 transmits a scene and keywords acquired from the scene in response to a request from the user terminal 200. The user terminal 200 displays the scene and the keywords such that the user can easily understand the scene.

The user terminal 200 includes an operation unit 201 and a display unit 202. The user operates the operation unit 201 to request video distribution, to designate a scene, to register a favorite scene, and the like. The display unit 202 displays the distributed video and displays a gauge for designating the playback position and scene of the distributed video.

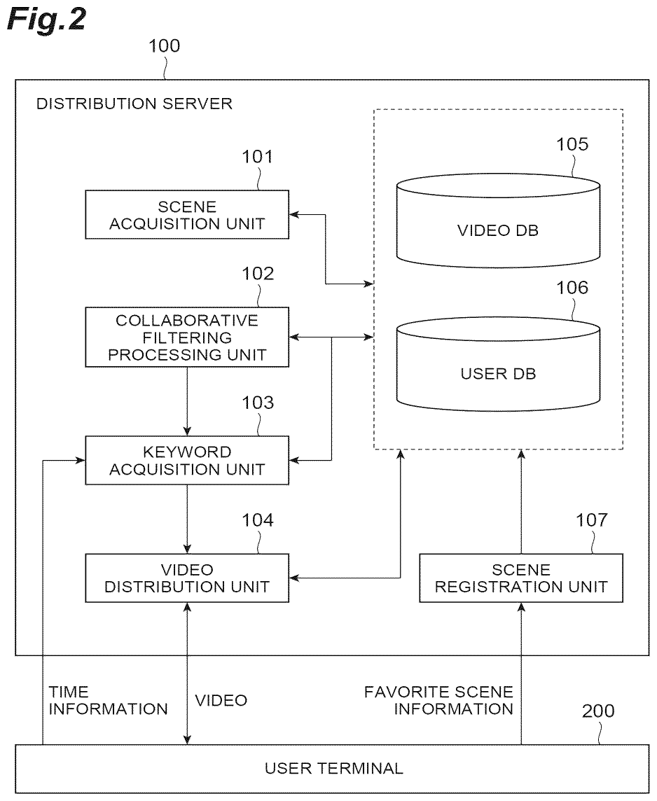

FIG. 2 is a block diagram showing a functional configuration of the distribution server 100. The distribution server 100 includes a scene acquisition unit 101, a collaborative filtering processing unit 102, a keyword acquisition unit 103, a video distribution unit 104, a scene registration unit 107, a video DB 105, and a user DB 106.

The scene acquisition unit 101 is a portion that acquires a video from the video DB 105 to acquire each scene. In the present disclosure, the scene indicates a scene having the same screen configuration from a screen change (a scene change in the video) to the next screen change in the video. Scene acquisition can compare images to detect a screen change. The scene is a video having a certain width. However, in the present disclosure, the scene indicates a still image portion within the width of the scene. The scene acquisition unit 101 registers a scene ID indicating a scene for each video in the video DB 105.

The collaborative filtering processing unit 102 is a portion performing a collaborative filtering process on the scenes registered as favorite scenes of one user to receive recommendations (recommendation target user) and other users with reference to the user DB 106 to acquire one or more scenes in each video to be recommended to the recommendation target user. That is, the collaborative filtering processing unit 102 acquires, as a recommended scene, a scene that has not been registered by the recommendation target user among the scenes registered as the favorite scenes of other users having a similar tendency to register favorite scenes as the recommendation target user.

The keyword acquisition unit 103 is a portion acquiring keywords from the recommended scene acquired by the collaborative filtering processing unit 102. The keyword acquisition unit 103 has a portion that has a known object detection model and recognizes images (objects and the like) included in the recommended scene (including a normal scene) to acquire keywords (text). For example, when a mountain is included in the scene, the keyword acquisition unit 103 recognizes the mountain as an object and acquires “mountain” as a keyword. The keyword acquisition unit 103 registers the keywords acquired from each recommended scene of each video as common keywords in the user DB 106 in association with the one user (recommendation target user) (FIG. 4(b)).

Further, the keyword acquisition unit 103 extracts keywords from the favorite scene registered by the one user (recommendation target user) and acquires the keywords as the common keywords, with reference to the user DB 106 (FIG. 4(a)). The keyword acquisition unit 103 registers the common keywords in the user DB 106 in association with the recommendation target user.

In this way, the keyword acquisition unit 103 can acquire the common keywords from the recommended scene obtained by the collaborative filtering and also acquire the common keywords from the scene registered as the favorite scene by the user. In addition, the keyword acquisition unit 103 may acquire only one of these keywords.

Independently of the above, the keyword acquisition unit 103 acquires keywords from the scene designated by the recommendation target user in the video being distributed by the video distribution unit 104 while the video is being distributed. That is, the keyword acquisition unit 103 receives position information indicating the playback position of the video from the user terminal 200, retrieves a scene based on the position information with reference to the video DB 105, and acquires keywords.

Then, the keyword acquisition unit 103 acquires a keyword matching the keyword stored as the common keyword in the user DB 106 among the acquired keywords and sets the acquired keyword as a presentation keyword.

The video distribution unit 104 is a portion that retrieves a video requested by the user terminal 200 from the video DB 105 and distributes the video. The video distribution unit 104 transmits the presentation keyword acquired by the keyword acquisition unit 103 to the user terminal 200 of the recommendation target user while distributing the video.

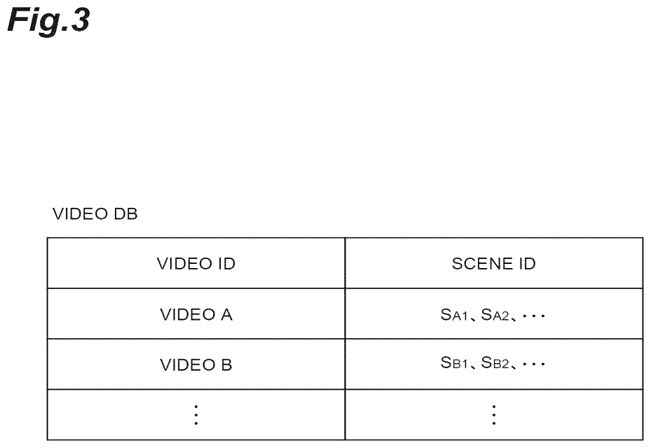

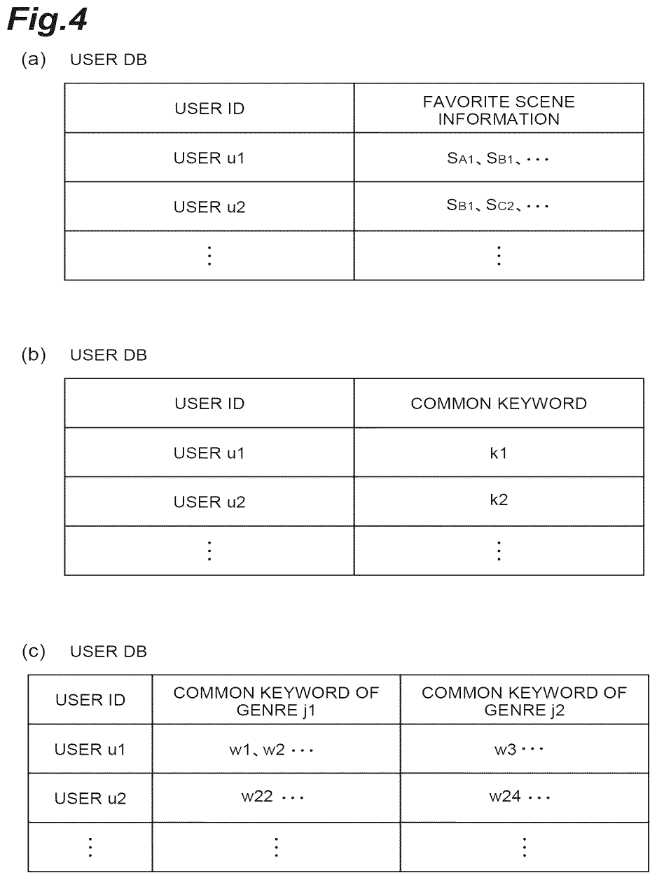

The video DB 105 is a portion storing videos and scene IDs of the videos in association with each other. FIG. 3 is a view showing a specific example of the video DB 105. As shown in FIG. 3, the video DB 105 stores video IDs and scene IDs in association with each other. The scene ID is further associated with the playback position (time information) (not shown).

The user DB 106 is a portion storing favorite scene information registered by the user and common keywords for each user. FIG. 4 is a view showing a specific example of a user DB. As shown in FIG. 4, FIG. 4(a) shows a database which stores the favorite scene information of each user and in which a user ID and favorite scene information are associated with each other. The favorite scene information is information registered from the user terminal 200 and is registered via the scene registration unit 107. FIG. 4(b) shows a user DB storing the common keywords of the users in association with each other. In the user DB 106, the user ID and the common keyword are associated with each other FIG. 4(c) is a view showing the user DB 106 in which the common keywords are set for each video genre. As shown in FIG. 4(c), the common keywords are stored for each video genre. The video genre indicates a classification of the video such as an action movie or a comedy movie. It is not essential to set the common keywords for each genre.

The scene registration unit 107 is a portion that acquires the favorite scene information transmitted from the user terminal 200 and registers the favorite scene information in the user DB 106.

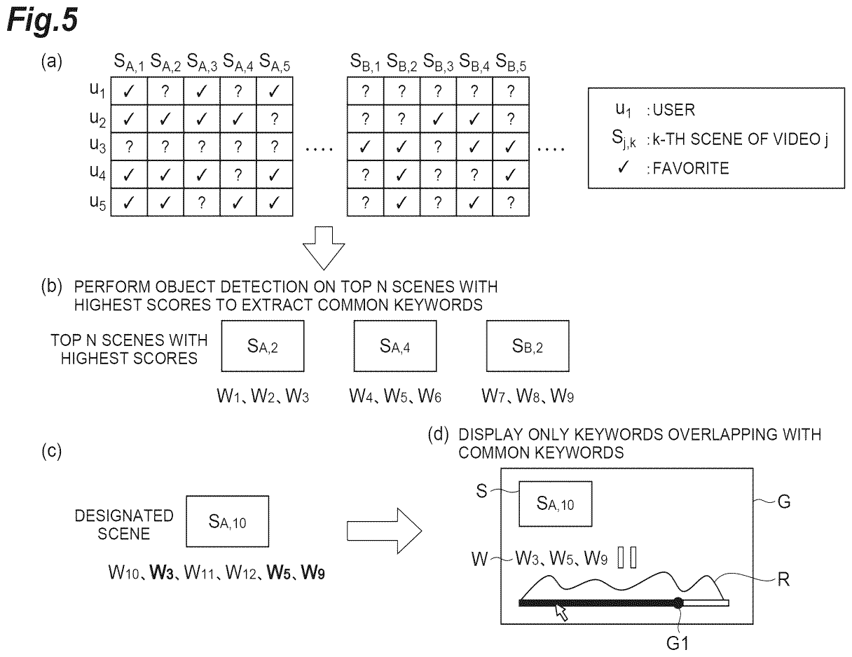

Next, an outline of the operation of the distribution server 100 will be described. FIG. 5 is a view showing an outline of an operation including the collaborative filtering process. FIG. 5(a) is a view showing a correspondence table between a plurality of users including the recommendation target user and the favorite scene information and corresponds to FIG. 4(a). FIG. 5(a) is a view for collaborative filtering. Here, ui indicates an i-th user and S_{j,k} indicates a k-th scene of a video j. A check mark indicates a scene registered as a favorite. A scene with a question mark ? indicates a scene that has not been registered as the favorite.

The collaborative filtering processing unit 102 acquires, for example, the scene to be recommended to the recommendation target user u1 based on the above-described data. Specifically, the collaborative filtering processing unit 102 acquires, as the recommended scenes, favorite scenes that have not been registered by the user u1 among the favorite scenes of other users u2, u3, . . . having a similar tendency to register favorites as the recommendation target user u1.

FIG. 5(b) is a view showing keywords acquired from the acquired recommended scenes. As shown in FIG. 5(b), the recommended scenes with the highest scores are acquired by the collaborative filtering. This score is calculated based on the proportion of the favorite scenes, which have not been registered by the user u1, but have been registered by other users, to the favorite scenes of other users having a similar tendency (high correlation) to register the favorite scenes as the user u1. For example, when the users u2 to u4 have registered the favorite scene, but the user u5 has not registered the favorite scene among the users u2 to u5 having a similar (highly correlation) tendency to register the favorite scenes as the user u1, the score is 0.75 (three persons/four persons). Therefore, this score indicates the degree of recommendation for the recommended scene.

Then, keywords are acquired from the top N (for example, the top three) favorite scenes. Here, keywords W₁, W₂, and W₃ are acquired from a scene S_{A,2}, keywords W₄, W₅, and W₆ are acquired from a scene S_{A,4}, and keywords W₇, W₈, and We are acquired from a scene S_{B,2}.

These acquired keywords are stored as the common keywords for the user u1 in the user DB 106 (FIG. 4(b)). In addition, the common keywords included in each scene and the score of the recommended scene may be stored in the user DB 106 in association with each other. When the common keyword is transmitted to the user terminal 200, the score may also be transmitted. The score may be displayed on the user terminal 200 in association with the common keyword. In this case, the user can understand that the common keyword is the keyword from the scene with a high degree of recommendation.

FIG. 5(c) shows that keywords have been extracted from the scene designated by the user u1 in the video that the user u1 has watched. Here, keywords W₁₀, W₃, W₁₁, W₁₂, W₅, and We are acquired. Among them, the keywords W₃, W₅, and W₉ matching the common keywords are extracted.

FIG. 5(d) is a view showing a display screen of the display unit 202 of the user terminal 200 on which the keywords overlapping with the common keywords are displayed. Here, the keywords W₃, W₅, and W matching the common keywords are displayed along with the scene S. As shown in FIG. 5(d), a screen G of the display unit 202 includes the scene S designated by the user, the keyword W₃ and the like of the scene S, a gauge G1, and a curve R superimposed on the video being viewed by the user. The gauge G1 indicates a designated location of the scene in the video. The curve R is formed based on the score of each scene calculated by the collaborative filtering. For the score, the score of each scene of the video to be distributed is calculated at a video distribution start timing or in advance, is transmitted, and is displayed on the screen G. In addition, here, the score is represented by a curve here, but may not be represented by a curve. The score is calculated for each scene, and there may be no corresponding scenes. Therefore, in practice, the score is often not represented by a curve.

Further, in FIG. 5, the common keywords are acquired without distinguishing genres. However, as described above, the collaborative filtering may be performed on the tendency to register the favorite scenes for each video genre to acquire the top N recommended scenes with the highest scores for each genre. In this case, the presentation keywords are narrowed down based on the common keywords set according to the genre of the video serving as the source of the scene designated in FIG. 5(c).

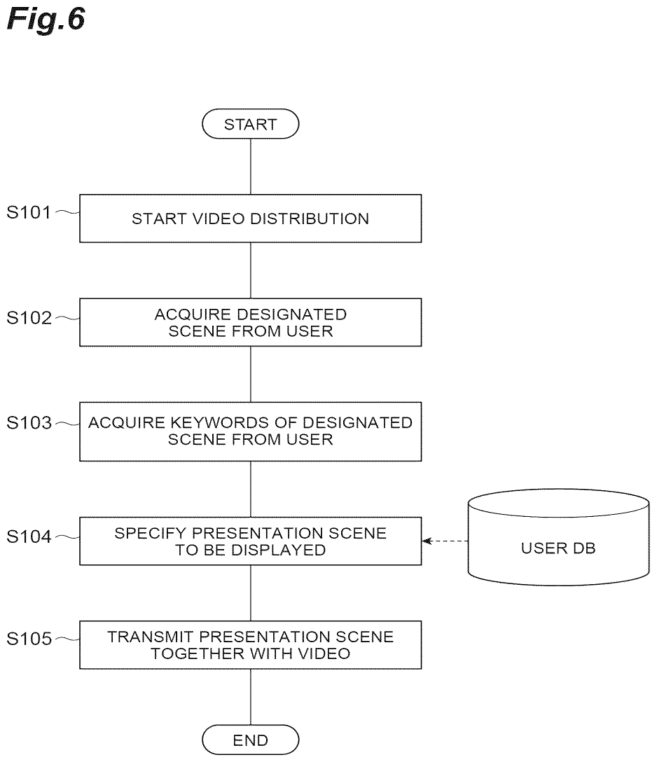

FIG. 6 is a flowchart showing a video distribution process of the distribution server 100 according to the present disclosure. The video distribution unit 104 retrieves the video requested by the user terminal 200 from the video DB 105 and distributes the video to the user terminal 200 (S101). Here, when the video to be distributed includes the recommended scene obtained by the collaborative filtering processing unit 102, the score calculated by the collaborative filtering process may also be distributed.

The user of the user terminal 200 operates an operation unit, such as a mouse, to designate any playback position on the gauge displayed together with the video playback screen. The user terminal 200 transmits its position information to the distribution server 100. This position may be indicated by time or may be a scene ID. In the present disclosure, this position information is time information.

In the distribution server 100, when receiving the position information from the user terminal 200, the keyword acquisition unit 103 retrieves a scene ID corresponding to the position information and a scene of the scene ID with reference to the video DB 105 (S102). Then, the keyword acquisition unit 103 acquires keywords from the scene (S103).

The keyword acquisition unit 103 specifies the presentation keywords to be displayed on the user terminal 200 (S104). That is, the keyword acquisition unit 103 recognizes the user ID, which is the distribution destination of the video, and acquires the corresponding common keywords using the user ID with reference to the user DB 106. Then, the keyword acquisition unit 103 specifies, as the presentation keywords, keywords matching the common keywords stored in the user DB 106 among the keywords acquired in the process S103. Then, the video distribution unit 104 transmits the presentation keywords so as to be displayed on the user terminal 200 together with the video (S105).

In addition, in the present disclosure, the user DB 106 may store the common keywords for each video genre, and the keyword acquisition unit 103 may acquire keywords matching the common keywords defined according to the genre among the keywords acquired from the scene specified by the user, according to the genre of the video being distributed. The video distribution unit 104 distributes the keywords.

In the user terminal 200, the distributed video is played back, and the user designates any scene during the playback of the video such that the keywords can be displayed. The keywords are keywords stored as the common keywords in the user DB 106 and are keywords matching the user's preferences.

In this way, the distribution server 100 can display the scene matching the user's preferences and the keywords of the scene on the user terminal 200. Instead of displaying all of the keywords retrieved from the scene, only the keywords matching the favorite scene registration tendencies of the recommendation target user are displayed. Therefore, it is possible to prevent unnecessary keywords from being displayed and to make the screen easier to read.

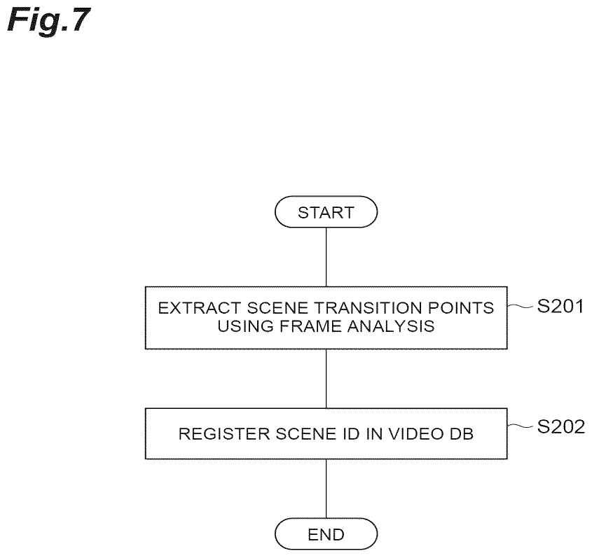

FIG. 7 is a flowchart showing the operation of the distribution server 100 acquiring scenes from a video. The scene acquisition unit 101 retrieves the video stored in the video DB 105 and extracts scene transition points using frame analysis (S201). Then, the scene acquisition unit 101 assigns a scene ID to each position separated by the transition points and registers the scene ID in the video DB 105 (S202). In the present disclosure, the video ID and the scene ID are stored in the video DB 105 in association with each other. However, the time information may also be stored in the video DB 105. The scene acquisition process is performed in advance. In addition, this process does not need to be performed in the distribution server 100, but may be performed by another device and registered in the video DB 105.

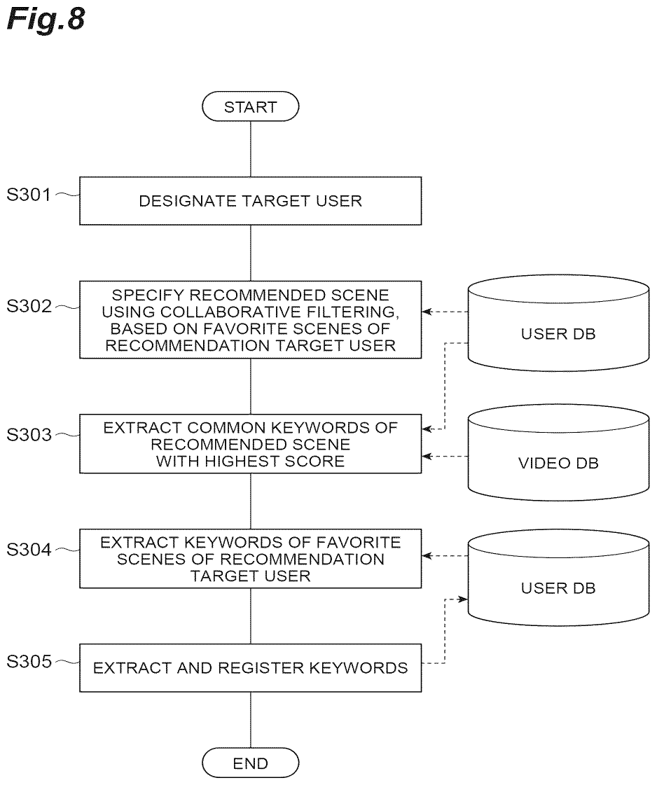

FIG. 8 is a flowchart showing the process when the common keywords are registered in the user DB 106. This process is performed periodically, and the common keywords are updated appropriately. The collaborative filtering processing unit 102 specifies the recommendation target user to be subjected to the collaborative filtering process (S301). The recommendation target users are designated in order. Then, the collaborative filtering processing unit 102 specifies a recommended scene using collaborative filtering, based on the favorite scenes of the recommendation target user (S302).

The keyword acquisition unit 103 extracts keywords from the recommended scene. Then, the keyword acquisition unit 103 extracts keywords matching the common keywords associated with the recommendation target user stored in the user DB 106 from the extracted keywords (S303).

Further, the keyword acquisition unit 103 extracts the favorite scene of the recommendation target user and extracts keywords from the favorite scene (S304).

Then, the keyword acquisition unit 103 registers the keywords extracted from the recommended scene and the keywords extracted from the favorite scene registered by the user as the common keywords in the user DB 106 (see FIG. 4(b)). However, when all of the keywords are registered in the user DB 106, the number of keywords becomes too large. Therefore, the most frequently extracted keywords among all of the keywords may be registered as the common keywords. In addition, priority may be given to keywords of the scene most recently registered as the favorite scene.

The common keywords registered here are treated as the keywords to be displayed on the user terminal 200.

Next, the operations and effects of the distribution server 100 and the user terminal 200 according to the present disclosure will be described. The distribution server 100 according to the present disclosure includes the video distribution unit 104 distributing a video to the user terminal 200 of one user and the keyword acquisition unit 103 acquiring keywords from the scene specified by the one user in the video. The video distribution unit 104 distributes the presentation keyword selected from the keywords so as to be displayed on the user terminal 200 together with the video.

This makes it possible for the user to easily view the scene and the keywords of the scene without displaying all of the keywords of the designated scene on the user terminal 200.

Further, the distribution server 100 according to the present disclosure includes the user DB 106 which is a storage unit storing the common keywords determined based on the registration tendencies of a specific scene registered by the one user and other users. The keyword acquisition unit 103 acquires the presentation keyword to be presented to the user from each scene of the video based on the common keywords. In the present disclosure, the specific scene is a favorite scene registered in advance by the user and is the user's favorite scene. However, the specific scene is not limited thereto and may be any scene specified based on some criteria or means.

The presentation keyword is obtained as follows. That is, the collaborative filtering processing unit 102 functioning as a recommended scene acquisition unit in the distribution server 100 acquires the recommended scenes based on the favorite scenes (specific scenes) of the one user and the other users in each of a plurality of videos. In this process, for example, the collaborative filtering process is performed to acquire the favorite scenes of other users having a similar tendency to register favorite scenes as the one user.

Then, the keyword acquisition unit 103 acquires keywords from the recommended scene, and the user DB 106 stores the acquired keywords as the common keywords.

This makes it possible to obtain the recommended scene from the favorite scenes of other users and to acquire the common keywords from the recommended scene. The presentation keywords are narrowed down based on the common keywords, which makes it possible to present an easy-to-view video screen, without presenting unnecessary keywords.

Further, the keyword acquisition unit 103 may store the genre of the video serving as the source of the recommended scene in the user DB 106, in addition to the common keywords, and acquire the presentation keywords based on the common keywords corresponding to the genre of the video being distributed.

This makes it possible to acquire the common keywords corresponding to the genre of the video being distributed and to present more appropriate keywords to the user.

Furthermore, in the distribution server 100 according to the present disclosure, the keyword acquisition unit 103 can acquire the common keywords based on the registration information of the favorite scene registered by one user and store the common keywords in the user DB 106.

That is, the keywords of the favorite scene registered by the user are used as the common keywords, which makes it possible to present the keywords matching the user's preferences to the user.

In addition, in the distribution server 100 according to the present disclosure, the user DB 106 stores the score indicating the degree of recommendation in association with the common keyword, and the video distribution unit 104 distributes the score of the common keyword in association with the presentation keyword.

This makes it possible for the user to understand that the presentation keyword has been acquired from the scene with a high degree of recommendation.

Further, in the distribution server 100 according to the present disclosure, the user DB 106 stores the favorite scenes for each user. Then, the video distribution unit 104 distributes the information (for example, the curve R) based on the score calculated by the collaborative filtering processing unit 102 such that the information can be displayed together with the presentation keyword.

That is, the collaborative filtering processing unit 102 calculates the recommended scene and the score indicating the degree of recommendation for the recommended scene. When the scene of the video being distributed matches the recommended scene, the video distribution unit 104 distributes information based on the score corresponding to the scene such that the information can be displayed on the user terminal 200. In the present disclosure, the curve R is displayed on the user terminal 200 so as to correspond to the scene of the video.

This makes it possible to visualize the score obtained by the collaborative filtering processing unit 102 in the user terminal 200. Graphing the score enables the user to intuitively understand the scene to be recommended.

The user terminal 200 according to the present disclosure is a user terminal receiving the video distributed from the distribution server 100. Then, the user terminal 200 includes a display unit displaying the video and the gauge indicating the playback position in the video and a receiving unit receiving any position on the gauge designated by one user. The display unit displays the scene corresponding to the designated position and the presentation keyword retrieved from the scene.

That is, when receiving position information in the video from the user terminal 200, the distribution server 100 recognizes a scene corresponding to the position information and acquires keywords from the scene. The distribution server 100 narrows down the keywords using the common keywords to obtain the representation keyword and transmits the representation keyword to the user terminal 200. The user terminal 200 displays the representation keyword.

This enables the user of the user terminal 200 to visually recognize the representation keyword.

The distribution server 100 according to the present disclosure has the following configuration.

[1] A distribution server comprising:
a video distribution unit distributing a video to a user terminal of one user; and
a keyword acquisition unit acquiring keywords from a scene designated by the one user in the video,
wherein the video distribution unit distributes a presentation keyword selected from the keywords so as to be displayed on the terminal together with the video.

[2] The distribution server according to [1], further comprising:
a storage unit storing common keywords determined based on registration tendencies of a specific scene registered by the one user and other users; and
a presentation keyword acquisition unit acquiring a presentation keyword to be presented to the user from each scene of the video based on the common keywords.

[3] The distribution server according to [2], further comprising:
a recommended scene acquisition unit acquiring a recommended scene based on the specific scenes of the one user and the other users in each of a plurality of videos;
a common keyword acquisition unit acquiring the common keywords from the recommended scene; and
a registration unit storing the common keywords in the storage unit.

[4] The distribution server according to [3],
wherein the recommended scene acquisition unit uses collaborative filtering.

[5] The distribution server according to [3] or [4],
wherein the registration unit stores, in the storage unit, a genre of the video serving as a source of the recommended scene in addition to the common keywords, and
the presentation keyword acquisition unit acquires the presentation keyword based on the common keywords corresponding to the genre of the video being distributed.

[6] The distribution server according to any one of [3] to [5],
wherein the common keyword acquisition unit acquires the common keywords based on registration information of the specific scene registered by the one user and stores the common keywords in the storage unit.

[7] The distribution server according to any one of [1] to [6],
wherein the video distribution unit distributes the presentation keyword corresponding to a genre of the video being distributed.

[8] The distribution server according to [2],
wherein the storage unit stores a score indicating a degree of recommendation of the scene serving as a source of the common keyword in association with the common keyword, and
the video distribution unit distributes the score in association with the presentation keyword.

[9] The distribution server according to any one of [3] to [6],
wherein the recommended scene acquisition unit calculates a score indicating a degree of recommendation for the recommended scene, and
the video distribution unit distributes information based on a score indicating the degree of recommendation corresponding to the scene of the video being distributed such that the information is capable of being displayed on the user terminal.

[10] A user terminal receiving a video distributed from the distribution server according to any one of [1] to [9], the user terminal comprising:
a display unit displaying the video and a gauge indicating a playback position in the video; and
a receiving unit receiving a designation of any position on the gauge from the one user,
wherein the display unit displays a scene corresponding to the designated position and the presentation keyword retrieved from the scene.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

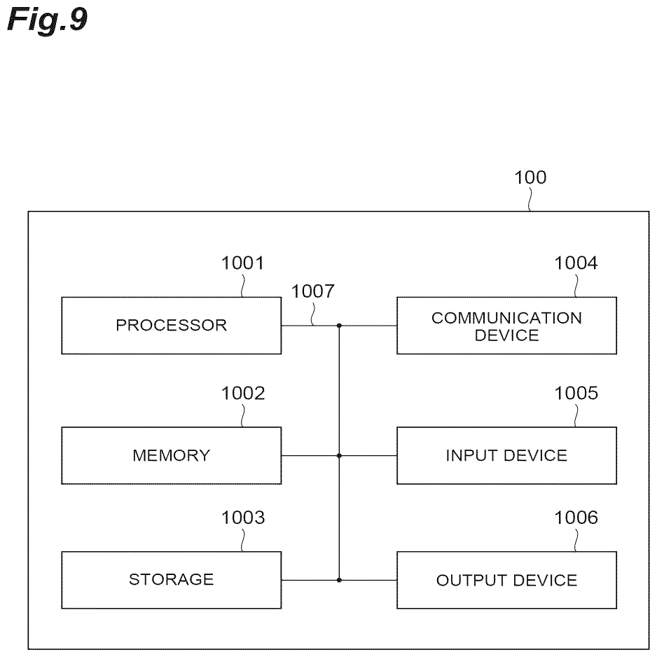

For example, the distribution server 100 and the like according to one embodiment of the present disclosure may function as a computer that performs processing of a video distribution method according to the present disclosure. FIG. 9 is a view showing an example of the hardware configuration of the distribution server 100 according to one embodiment of the present disclosure. The distribution server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the distribution server 100 may be configured to include one or a plurality of the devices shown in the drawings or may be configured without including some of those devices.

The functions of the distribution server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the collaborative filtering processing unit 102, the keyword acquisition unit 103 be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the collaborative filtering processing unit 102, the keyword acquisition unit 103 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a video distribution method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described video distribution unit 104 may be implemented by the communication device 1004. The transmitting and receiving unit may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the distribution server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100: distribution server, 200: user terminal, 101: scene acquisition unit, 102: collaborative filtering processing unit, 103: keyword acquisition unit, 104: video distribution unit, 107: scene registration unit, 105: video DB, 106: user DB.

1. A distribution server comprising:
a video distribution unit distributing a video to a user terminal of one user; and
a keyword acquisition unit acquiring keywords from a scene designated by the one user in the video,
wherein the video distribution unit distributes a presentation keyword selected from the keywords so as to be displayed on the terminal together with the video.

2. The distribution server according to claim 1, further comprising:
a storage unit storing common keywords determined based on registration tendencies of a specific scene registered by the one user and other users; and
a presentation keyword acquisition unit acquiring a presentation keyword to be presented to the user from each scene of the video based on the common keywords.

3. The distribution server according to claim 2, further comprising:
a recommended scene acquisition unit acquiring a recommended scene based on the specific scenes of the one user and the other users in each of a plurality of videos;
a common keyword acquisition unit acquiring the common keywords from the recommended scene; and
a registration unit storing the common keywords in the storage unit.

4. The distribution server according to claim 3,
wherein the recommended scene acquisition unit uses collaborative filtering.

5. The distribution server according to claim 3,
wherein the registration unit stores, in the storage unit, a genre of the video serving as a source of the recommended scene in addition to the common keywords, and
the presentation keyword acquisition unit acquires the presentation keyword based on the common keywords corresponding to the genre of the video being distributed.

6. The distribution server according to claim 3,
wherein the common keyword acquisition unit acquires the common keywords based on registration information of the specific scene registered by the one user and stores the common keywords in the storage unit.

7. The distribution server according to claim 1,
wherein the video distribution unit distributes the presentation keyword corresponding to a genre of the video being distributed.

8. The distribution server according to claim 2,
wherein the storage unit stores a score indicating a degree of recommendation of the scene serving as a source of the common keyword in association with the common keyword, and
the video distribution unit distributes the score in association with the presentation keyword.

9. The distribution server according to claim 3,
wherein the recommended scene acquisition unit calculates a score indicating a degree of recommendation for the recommended scene, and
the video distribution unit distributes information based on a score indicating the degree of recommendation corresponding to the scene of the video being distributed such that the information is capable of being displayed on the user terminal.

10. A user terminal receiving a video distributed from the distribution server according to claim 1, the user terminal comprising:
a display unit displaying the video and a gauge indicating a playback position in the video; and
a receiving unit receiving a designation of any position on the gauge from the one user,
wherein the display unit displays a scene corresponding to the designated position and the presentation keyword retrieved from the scene.
